(19) United States
(12) Patent Application Publication
(10) Pub. No.: US 2003/0021655 A1
(43) Pub. Date: Jan. 30, 2003

(54) Staple - polypropylene injection molded

(76) Inventors: Richard Peter Correll, Buffalo, MN (US); Bernard Ervin Durand, Buffalo, MN (US)

Correspondence Address: Richard Peter Correll, 1204 Culver Avenue NW, Buffalo, MN, 55313, US

(21) Appl. No.: 09/915,999

(22) Filed: Jul. 27, 2001

(51) Int. Cl. F16B 15/02

(52) U.S. Cl. 411/473

(57) ABSTRACT

A polypropylene injection molded staple, which are melted together by a heating process in strips, for use in a mechanical staple-driving machine. The individual staples have sufficient strength and flexibility to secure plastic tubing to polystyrene insulation for radiant floor and snow melt heating systems.

### BACKGROUND OF THE INVENTION

Hydronic heating systems are a popular way of heating an area by circulating a warmed fluid through tubing, pipes or radiators. In a hydronic floor heating system, also known as radiant floor heating, heated fluid is circulated through plastic tubing within the floor structure, which distributes the heat throughout the entire floor, therefore heating the area. In a radiant floor heating system whereas the floor is concrete, polystyrene insulation is installed below the concrete to prevent downward heat loss, plastic tubing is then fastened to the polystyrene to hold the tubing in place, and to prevent it from floating, when the concrete is applied. This practice is also used for snowmelt in colder regions for driveways, parking lots, and sidewalks.

A variety of means of fastening the plastic tubing to the polystyrene are known in the art, each having its own drawbacks. In one prior art wire mesh is cut and placed on top of the polystyrene, and the plastic tubing is then tied to the wire mesh by means of wire ties or plastic ties, both much more labor intensive and more expensive.

In another prior art, another plastic staple was used to fasten the plastic tubing to the polystyrene. This staple was joined together by means of masking tape, which would bend, twist, and even drop off staples, which would make loading a mechanical staple-driving machine very cumbersome. This staple would also pull out of the polystyrene at different points, thus needing to go back through the task at hand and refasten the plastic tubing to the polystyrene.

### SUMMARY OF THE INVENTION

It is the primary object of the present invention to advance the art of radiant floor and radiant snow melt systems of a more secure means of fastening plastic tubing to polystyrene insulation. The advantages of the present invention are achieved with the three barbs located at two different levels on the driven shafts of the staple, which flex outward as pressure is pulled upward on the staple or tubing.

### BRIEF DESCRIPTION OF THE DRAWINGS

FIG. 1 is a cross-section view of a radiant floor heat system

FIG. 2 is a cross-section view of a plastic tube fastened by the present invention to polystyrene insulation, and poured over with concrete in a radiant floor heat system.

FIG. 3 is an isometric view of the present invention

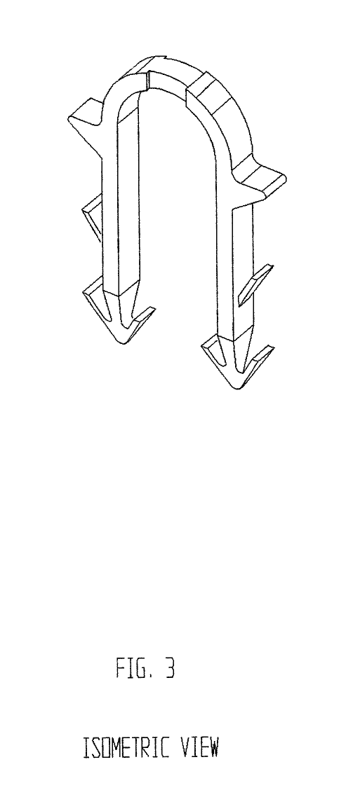

FIG. 4 is a top view of the present invention

FIG. 5 is a side view of the present invention

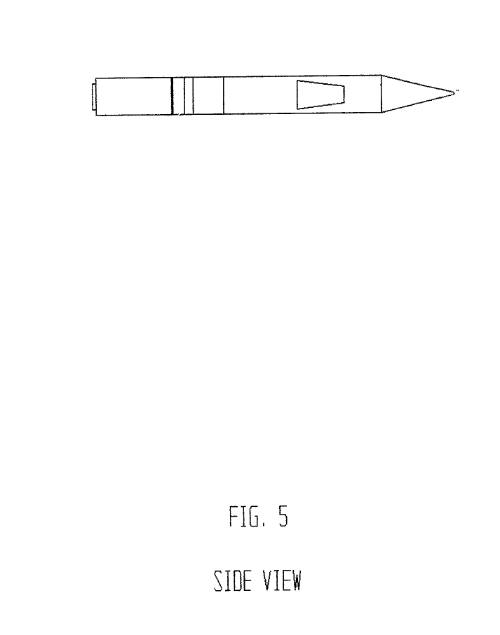

FIG. 6 is a view of a pack of foam staples, which is used, in a mechanical staple-driving machine.

### DETAILED DESCRIPTION OF THE INVENTION

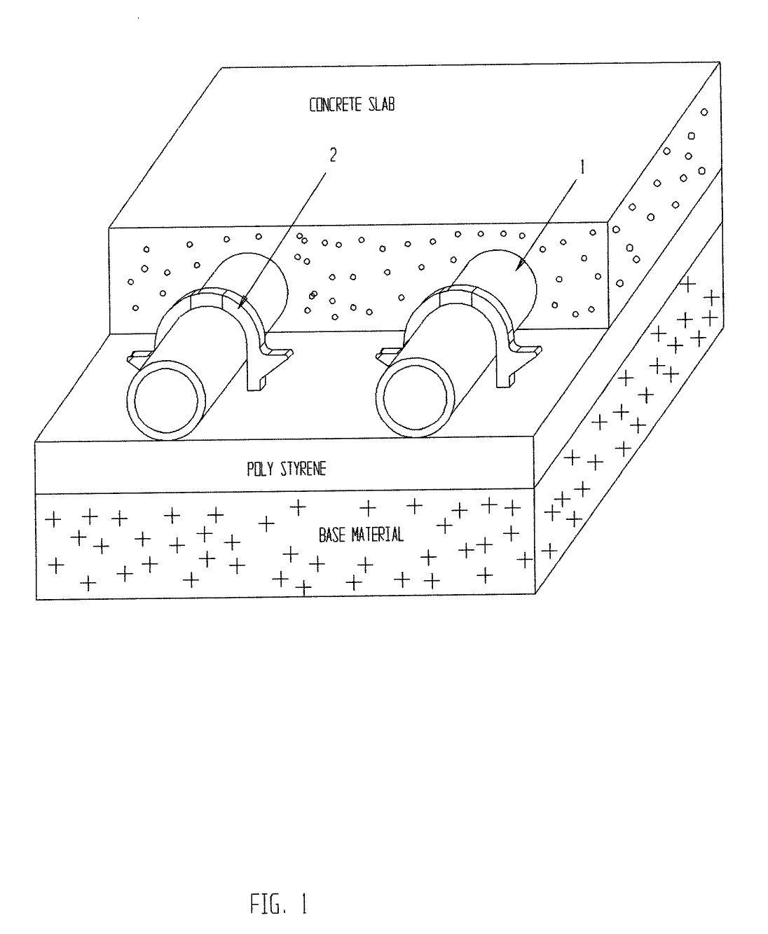

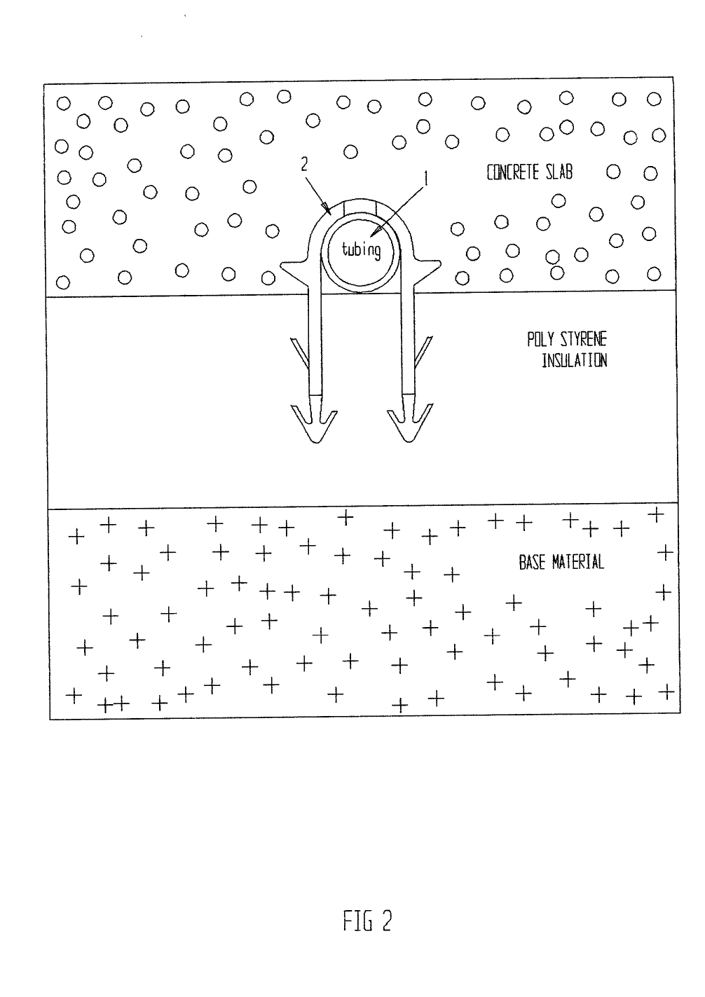

In a typical radiant floor and snow melt heat system placed on grade (FIGS. 1 and 2); polystyrene insulation will be placed on sand, gravel, or other base material. Plastic tubing 1 which heated fluid is circulated through is then installed and fastened to the polystyrene by the present invention or foam staple 2. Concrete is then applied over the plastic tubing, staples, and polystyrene.

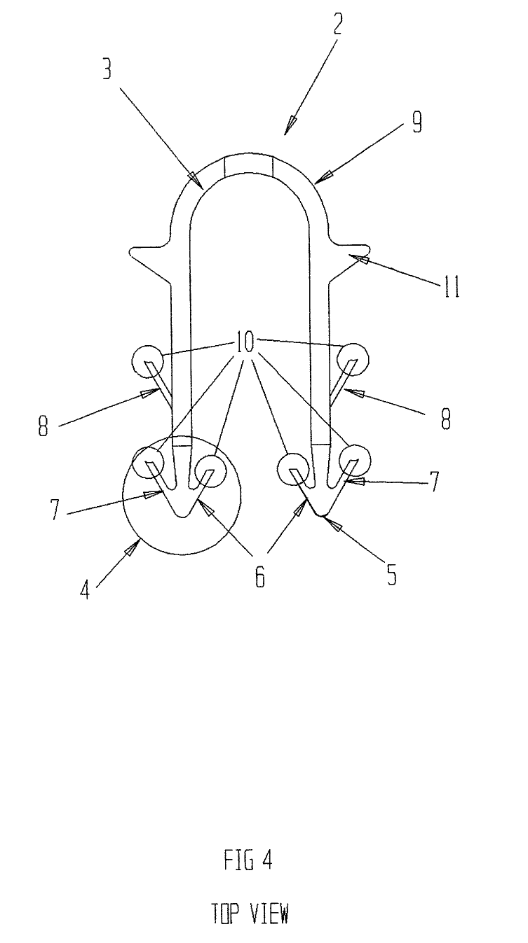

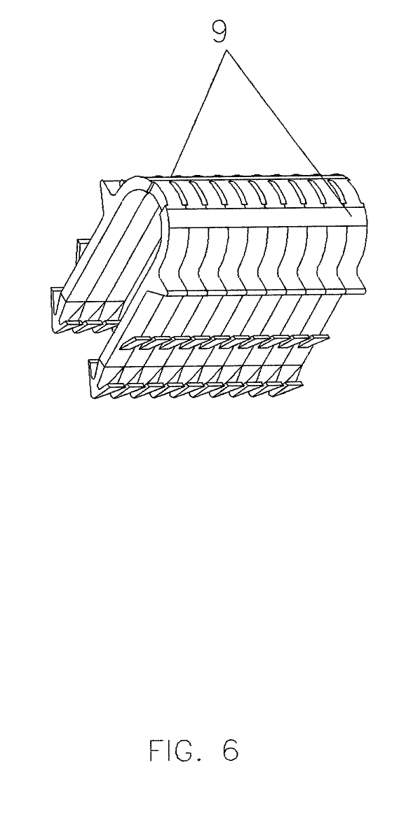

The foam staple 2 can be inserted into the polystyrene by hand as individual staples, or FIG. 6 as a pack, by using a mechanical staple-driving machine. The foam staple as a pack (FIG. 6) are melted together on the upper outer radius 9, to join them together and keeping them rigid from side to side motions yet giving enough flexibility to bend in an upward direction allowing them to feed through a mechanical staple-driving machine. (FIG. 4) The foam staple 2 is made of polypropylene by process of plastic injection molding, with an inside radius 3 of 0.375′ to facilitate securing ⅜, ½, and ⅝ inch plastic tubing 1. The foam staple 2 has one set of barbs 4 on each end that comes to a rounded point 5 of 0.05′ to help penetration into the polystyrene when inserted. At the set of barbs 4 the inside barb 6 is 0.3′ long and the outside barb 7 is 0.36′ long. The inside barb 6 is shorter as it has to pass by the outer diameter of the plastic tubing 1 as it is inserted into the polystyrene. The single outside barbs 8 are 0.3′ long and are located as to fasten the plastic tubing 1 more securely in thinner polystyrene. Most applications of radiant floor and snow melt systems use 2′ polystyrene, but depending on the downward heat loss, and what temperatures need to be maintained, different thickness' of polystyrene are used. When ¾, or 1 inch polystyrene are used, the outside barbs 8 lock into the polystyrene securing the plastic tubing 1, whereas the sets of barbs 4 are located completely through the polystyrene thus not securing the plastic tubing 1 firmly without the aid of the outside barbs 8. A flat angle 10 is cut at the end of all barbs 6, 7,and 8. This angle 10 gives much more holding power to the foam staple 2, whereas when the foam staple 2 is pulled upward, the angle 10 pushes and flexes the barbs 6, 7,and 8 outward thus creating more holding power. A mechanical staple-driving machine uses the tabs 11 on the outer edge of the foam staple 2, by thrusting force down on the tabs 11 until the foam staple 2, is inserted completely into the polystyrene thus fastening the plastic tubing 1 securely. into the polystyrene securing the plastic tubing 1, whereas the sets of barbs 4 are located completely through the polystyrene thus not securing the plastic tubing 1 firmly without the aid of the outside barbs 8. A flat angle 10 is cut at the end of all barbs 6, 7,and 8. This angle 10 gives much more holding power to the foam staple 2, whereas when the foam staple 2 is pulled upward, the angle 10 pushes and flexes the barbs 6, 7,and 8 outward thus creating more holding power. A mechanical staple-driving machine uses the tabs 11 on the outer edge of the foam staple 2, by thrusting force down on the tabs 11 until the foam staple 2, is inserted completely into the polystyrene thus fastening the plastic tubing 1 securely.

What I claim is my invention is:

1. A staple formed from a resilient plastic material and adapted to be used in a mechanical staple-driving machine for fastening plastic tubing to polystyrene insulation for radiant floor and snow melt heat systems, said staple packs comprising of;
(a) a backspan with a 0.375 internal radius; and
(b) two prongs integrally connected and extending perpendicular from said backspan in substantially parallel relationship to each other, each prong having a shaft portion with one barb, and a rounded tip portion with two barbs; and
(c) melted together on the upper outside radius by a heating process to keep flexibility upward and rigidity sideways.
